(19) United States
(12) Patent Application Publication
(10) Pub. No.: US 2025/0200597 A1
(43) Pub. Date: Jun. 19, 2025

(54) AMBIGUITY RESOLUTION THROUGH PARTICIPANT FEEDBACK

(71) Applicant: INTERNATIONAL BUSINESS MACHINES CORPORATION, ARMONK, NY (US)

(72) Inventors: Robert Huntington Grant, Marietta, GA (US); Zachary A. Silverstein, Georgetown, TX (US); AMANDA NICOLE WILK, New York, NY (US); BRUNO HUPIN, Ipswich, MA (US)

(21) Appl. No.: 18/537,965

(22) Filed: Dec. 13, 2023

(51) Int. Cl. G06Q 30/0203; G06F 11/34

(52) U.S. Cl. CPC G06Q 30/0203; G06F 11/3476

(57) ABSTRACT

Described is a method for transforming an active process utilizing participant feedback and generating a new workflow for an enhanced and accelerated process includes capturing an active process with a plurality of components based on a plurality of event log files and a plurality of relevant participants of the active process. The method also includes identifying, based on the plurality of event log files, ambiguity associated with at least one component of the active process. The method also includes sending a poll to at least a portion of relevant participants from the plurality of relevant participants, where the poll identifies the ambiguity and includes a request to resolve the ambiguity. The method also includes receiving feedback from the portion of relevant participants and generating a new process by transforming the active process based on the feedback from the portion of relevant participants.

### BACKGROUND

This disclosure relates generally to process mining tools, and in particular to ambiguity resolution through participant feedback for process mining tools.

Process mining tools is software that performs various techniques to discover, monitor, and improve processes by extracting readily available knowledge from event logs of information systems. The process mining tool includes automated process discovery through extraction of process models from an event log and conformance checking through the monitoring of deviation by comparing model and event log. Process mining tools are utilized across a broad spectrum of industries that include utilities, banking, and manufacturing. Process mining tools can often miss capturing elements of a process that would otherwise be obvious to user. These missing elements are subsequently incorporated into the process visualization with low fidelity, which can affect results generated by the process mining tool.

### SUMMARY

Embodiments in accordance with the present invention disclose a computer-implemented method, a computer program product, and a computer system for transforming an active process utilizing participant feedback and generating a new workflow for an enhanced and accelerated process, the computer-implemented method, the computer program product, and the computer system capture an active process with a plurality of components based on a plurality of event log files. The computer-implemented method, the computer program product, and the computer system capture a plurality of relevant participants of the active process. The computer-implemented method, the computer program product, and the computer system identify, based on the plurality of event log file, ambiguity associated with at least one component of the active process. The computer-implemented method, the computer program product, and the computer system send a poll to at least a portion of relevant participants from the plurality of relevant participants, wherein the poll identifies the ambiguity and includes a request to resolve the ambiguity. The computer-implemented method, the computer program product, and the computer system receive feedback from the portion of relevant participants. The computer-implemented method, the computer program product, and the computer system generate a new process by transforming the active process based on the feedback from the portion of relevant participants.

### BRIEF DESCRIPTION OF THE SEVERAL VIEWS OF THE DRAWINGS

FIG. 1 is a functional block diagram illustrating a computing environment, in accordance with an embodiment of the present invention.

FIG. 2 depicts a flowchart of an ambiguity resolution program to transform an active process utilizing participant feedback and generate a new workflow for an enhanced and accelerated process, in accordance with an embodiment of the present invention.

### DETAILED DESCRIPTION

According to an aspect of the invention, there is provided a computer-implemented method, a computer program product, and a computer system that includes capturing an active process with a plurality of components based on a plurality of event log files. The computer-implemented method, the computer program product, and the computer system further includes capturing a plurality of relevant participants of the active process. The computer-implemented method, the computer program product, and the computer system further includes identifying, based on the plurality of event log files, ambiguity associated with at least one component of the active process. The computer-implemented method, the computer program product, and the computer system further includes sending a poll to at least a portion of relevant participants from the plurality of relevant participants, where the poll identifies the ambiguity and includes a request to resolve the ambiguity. The computer-implemented method, the computer program product, and the computer system further includes receiving feedback from the portion of relevant participants. The computer-implemented method, the computer program product, and the computer system further includes generating a new process by transforming the active process based on the feedback from the portion of relevant participants. A technical advantage includes enhancing and accelerating process times for various industries ranging from banking to manufacturing through ambiguity resolution in event log files. Utilizing relevant participant feedback to resolve ambiguity in the event log files of the process, allows for improved efficiency in industry specific processes (e.g., bank loan processing times, manufacturing lead times).

In embodiments, the computer-implemented method, the computer program product, and the computer system can optionally include each relevant participant from the plurality of relevant participants is a subject matter expert with an associated level of subject matter expertise. A technical advantage includes utilizing relevant participants based on an associated level of subject matter expertise, where the feedback provided by each of the relevant participants can be aggregated to accurately resolve the ambiguity associated with the one component of the active process.

In embodiments, the computer-implemented method, the computer program product, and the computer system can optionally include the ambiguity associated with the at least one component of the active process is determined based on one or more of black boxes, application programming interface (API) endpoints, third party integrations, unknown approval steps, and offline steps. A technical advantage includes identifying each of the various types of ambiguities that can be associated with the process that can adversely affect the process mining.

In embodiments, the computer-implemented method, the computer program product, and the computer system can optionally include receiving a user opt-in selection for each relevant participants from the plurality of relevant participants who is a subject matter expert in a field associated with a given process. A technical advantage includes maintaining privacy of each relevant participant from the plurality of relevant participants by requiring that each relevant participant provide a user opt-in selection so that they can be polled for feedback to resolve any ambiguity with a process.

In embodiments, the computer-implemented method, the computer program product, and the computer system can optionally include aggregating the feedback received from the portion of relevant participants. The computer-implemented method, the computer program product, and the computer system can optionally include generating a commonality score that includes usernames involved, potentially missing process steps, additional business process model and notation (BPMN) flow components, and diagram adjustments based on the aggregated feedback of the participants. A technical advantage includes aggregating the feedback to ensure a proper ambiguity resolution is identified based on the commonality score, where the feedback allows for the generating of the new process through the transforming of the active process based on the aggreged feedback from the relevant participants.

In embodiments, the computer-implemented method, the computer program product, and the computer system can optionally include weighing the feedback received from the portion of relevant participants based on an associated level of subject matter expertise for each participant from the portion of relevant participants. A technical advantage includes further aggregating the feedback by weighing the feedback based on an associated level of subject matter expertise for each of the relevant participants that provided feedback. Thus, resulting in a more accurate and directed resolution to the ambiguity associated with the at least one component of the active process.

In embodiments, the computer-implemented method, the computer program product, and the computer system can optionally include determining whether additional data is required based on an amount of feedback received from the portion of relevant participants. In embodiments, the computer-implemented method, the computer program product, and the computer system can optionally include, in response to determining the additional data is required the active process with the plurality of components based on the plurality of event log files. In embodiments, the computer-implemented method, the computer program product, and the computer system can optionally include capturing another plurality of relevant participants of the active process, where the portion of relevant participants are removed from the other plurality of relevant participants of the active process. A technical advantage includes determining when the provided feedback (i.e., data) from the relevant participants is not enough to resolve the ambiguity associated with the at least one component of the active process. Therefore, another plurality of relevant participants is captured to poll for additional feedback, where the other plurality of relevant participants excluded a portion of relevant participants for which feedback was already received. Thus, resulting in the exclusion of potentially repetitive data which can skew the results and adversely affect the resolution to the ambiguity.

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments. It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

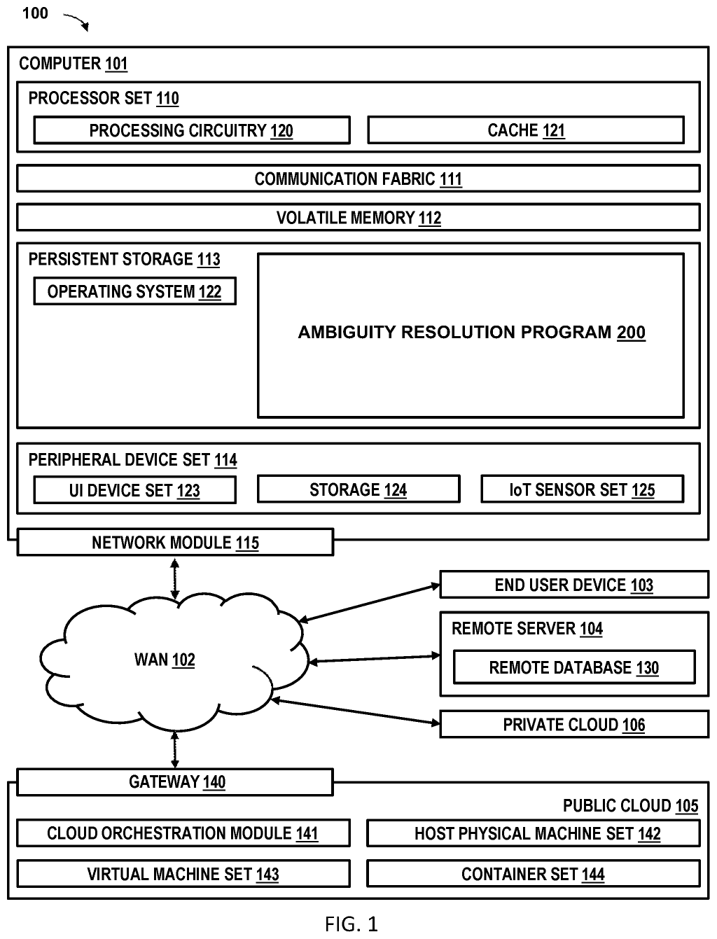

FIG. 1 is a functional block diagram illustrating a computing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 contains an example of an environment for the execution of at least some of the computer code involved in performing the inventive methods, such as, ambiguity resolution program 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

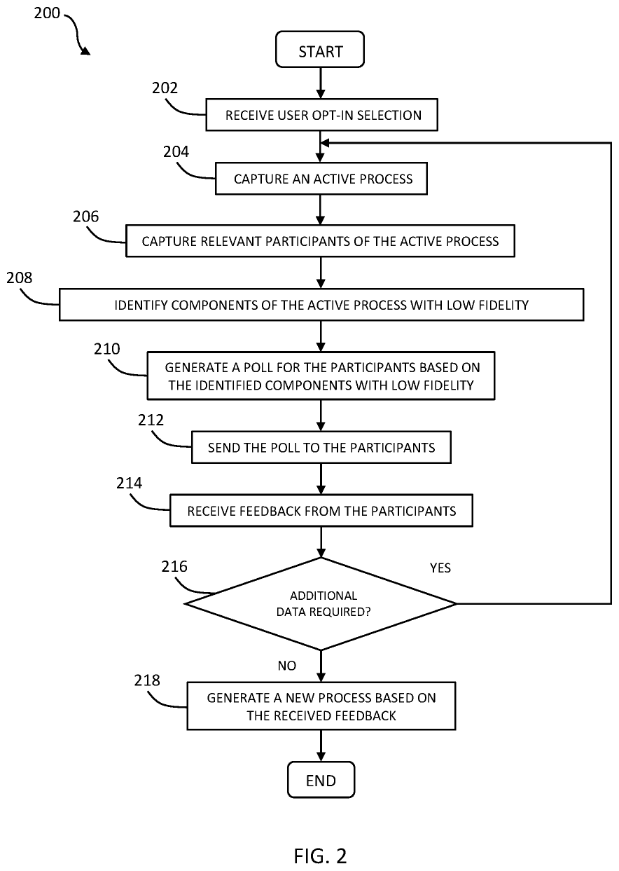

FIG. 2 depicts a flowchart of an ambiguity resolution program to transform an active process utilizing participant feedback and generate a new workflow for an enhanced and accelerated process, in accordance with an embodiment of the present invention.

Ambiguity resolution program 200 receives a user opt-in selection (202). For ambiguity resolution program 200 to generate a new workflow for an enhanced and accelerated process utilizing participant feedback, ambiguity resolution program 200 receives a user opt-in selection from multiple users (i.e., participants) who are subject matter experts (SME) in a field (e.g., banking, manufacturing) associated with a given process. The greater the number of participants who provide feedback and process guidance to ambiguity resolution program 200, the greater a likelihood a resolution for ambiguity can be achieved for the process. In one example, a bank is attempting to streamline operations by reducing loan processing times, where the reduced loan processing times result in lowered operational costs and increased customer satisfaction. Ambiguity resolution program 200 can receive user opt-in selections from various engineers implementing the process mining tools, along with various bank employees that handle a loan request at various points along the process, from an initial customer interaction at a local branch to a final funds transfer between the bank and the customer. In another example, an electronics manufacturer is attempting to lower lead times for deliveries, where the lower lead times result in lowered operational costs, increased operational efficiency, and accelerated deliveries. Ambiguity resolution program 200 can receive user opt-in selections from various engineers implementing the process mining tools, along with various electronic manufacturer employees involved with the manufacturing and logistical preparations. This can include an employee from an initial customer and client interaction when receiving an order to an employee handling the logistical preparations of the product prior to the hand off to the logistical company.

Ambiguity resolution program 200 captures an active workflow for the process (204). Ambiguity resolution program 200 captures the active workflow for the process by extracting process and task mining event log files. An event log files represents data for each task in the process, where each event log entry includes various data utilized for each task in the process being performed. In the example where a bank is attempting to streamline operations by reducing loan processing times, process and task mining event log files can include a large quantity of various data ranging from loan applicant information to various internal bank loan processing metrics. An example of a task in the loan processing that ambiguity resolution program 200 can capture includes automation of receiving the loan applicant information. In the example where an electronics manufacturer is attempting to lower lead times for deliveries, process and task mining event log files can include a large quantity of various data ranging from customer account information to various internal manufacturing metrics for each step of a manufacturing process.

Ambiguity resolution program 200 captures relevant participants of the active process (206). For each task in a process, ambiguity resolution program 200 can append a level of SME aptitude based on an execution counts for a specific task. In the example where a bank is attempting to streamline operations by reducing loan processing times, ambiguity resolution program 200 captures relevant participants that includes various engineers implementing the process mining tool and the various bank employees that handle loans requests at various points along the process. Though implementing a process mining tool is handled by various engineers, ambiguity can exist as it relates to specific tasks that are performed during the handling of the loan requests, which are discussed in further detail with regards to (208). Therefore, ambiguity resolution program 200 identifies SMEs among the various bank employees that have opted-in and a level of aptitude for each SME as it relates to specific tasks associated with the handling of the loan request (e.g., government compliance, security compliance, risk compliance). In the example where an electronics manufacturer is attempting to lower lead times for deliveries, ambiguity resolution program 200 captures relevant participants that includes various engineers implementing the process mining tool and the various manufacturer employees that handle the manufacturing and the logistical preparations of the products. Ambiguity can exist as it relates to specific task that performed during the manufacturing and the logistical preparations of the products, which are discussed in further detail with regards to (208). Therefore, ambiguity resolution program 200 identifies SMEs among the various manufacturer employees that have opted-in and a level of aptitude for each SME as it relates to specific tasks associated with the handling of the products (e.g., safety compliance, quality control, inventory management).

Ambiguity resolution program 200 identifies components of the active process with low fidelity (208). Ambiguity resolution program 200 utilizes the event log files and/or user input to identify components of the active process with low fidelity (i.e., ambiguity). Ambiguity resolution program 200 determines ambiguity in the process based on black boxes, application programming interface (API) endpoints, third party integrations, unknown approval steps, and/or offline steps. Black boxes represent one or more tasks in the process where input data and output data are defined, but the transformation of the input data and the output data is not defined. API endpoints represent specific locations within an API that accepts requests and sends back responses, where there is communication between two or more computer programs in the process. Third party integration represents one or more tasks in the process performed by a third party, where software from the third party is incorporated into the process mining tool. Unknown approval steps represent instance where one or more tasks in the process receive and/or request approval from unknown entities. Offline steps represent one or more tasks in the process that perform steps offline that are not trackable with event log files.

In the example where a bank is attempting to streamline operations by reducing loan processing times, ambiguity resolution program 200 identifies components of the process that includes ambiguity utilizing the event log files. Based on the event log files, ambiguity resolution program 200 identifies that multiple unknown approval steps are present in the loan process, where the unknown approval steps represent an instance of ambiguity that is present in the process of handling loan requests. In the example where an electronics manufacturer is attempting to lower lead times for deliveries, ambiguity resolution program 200 identifies components of the process that includes ambiguity utilizing user input, where ambiguity resolution program 200 receives the user input through the process mining tool. Based on the user input, ambiguity resolution program 200 identifies multiple third party integrations that represent multiple instances of ambiguity that are present in the process of manufacturing and logistical preparation. The third party integrations can include software for inventor management and logistical handling, where an availability of event log files is limited for the software provided through the third party integrations.

Ambiguity resolution program 200 generates a poll for the participants based on the identified components with low fidelity (210). Ambiguity resolution program 200 generates a poll (i.e., a query) for additional data associated with the identified components of the active process with low fidelity. Since ambiguity resolution program 200 previously captured relevant participants of the active process, ambiguity resolution program 200 can generate a different query to each relevant participant based on the participant's subject matter expertise and a level of subject matter expertise. In some embodiment, ambiguity resolution program 200 can also generate a different query to each relevant participant based on availability of the participant and a security clearance of the participant. Ambiguity resolution program 200 can utilize a random or a non-random stratified sample of the participants to resolve the ambiguity which was identified through the low fidelity components of the process. In the example where a bank is attempting to streamline operations by reducing loan processing times and identifies ambiguity based on multiple unknown approval steps being present in the loan process, ambiguity resolution program 200 generates a query for additional data to the participants based on identified ambiguity. Additionally, ambiguity resolution program 200 identifies which participants from the bank employees to query based on participant's subject matter expertise and a level of subject matter expertise as it relates to the multiple unknown approval steps. In the example where an electronics manufacturer is attempting to lower lead times for deliveries and identifies multiple third party integrations that represent multiple instances of ambiguity are present in the process of manufacturing and logistical preparation, ambiguity resolution program 200 generates a query for additional data to the participants based on identified ambiguity. Additionally, ambiguity resolution program 200 identifies which participants from the manufacturer employees to query based on participant's subject matter expertise and a level of subject matter expertise as it related to the multiple third party integrations.

Ambiguity resolution program 200 sends the poll to the participants (212). In this embodiment, ambiguity resolution program 200 sends the poll to the participants in the form of a workflow or process mining portal, where the participants being queried can provide specific feedback as it relates to the ambiguity in the process. In the poll, ambiguity resolution program 200 displays the identified ambiguity as it relates to one or more of black boxes, application programming interface (API) endpoints, third party integrations, unknown approval steps, and offline steps. Ambiguity resolution program 200 can query the participant to provide feedback as to how to resolve the ambiguity associated with the process.

Ambiguity resolution program 200 receives feedback from the participants (214). Ambiguity resolution program 200 receives the feedback from the participants and gauges the participant feedback by means of natural language extraction based on k-nearest neighbor (KNN) clustering and cosine similarity. Ambiguity resolution program 200 aggregates the feedback and generates a commonality score that includes usernames involved, potentially missing process steps, additional business process model and notation (BPMN) flow components, and diagram adjustments based on the aggregated feedback of the participants. In some embodiments, ambiguity resolution program 200 weighs the feedback based on the participant providing the feedback and a level of subject matter expertise associated with the participant. In the example a bank is attempting to streamline operations by reducing loan processing times and identifies ambiguity based on multiple unknown approval steps being present in the loan process, ambiguity resolution program 200 receives feedback from the participants that further define the unknown approval steps. In the example where an electronics manufacturer is attempting to lower lead times for deliveries and identifies multiple third party integrations that represent multiple instances of ambiguity are present in the process of manufacturing and logistical preparation, ambiguity resolution program 200 receives feedback from the participants that further define the third party integrations of software into the manufacturing and logistical preparation process.

Ambiguity resolution program 200 determines whether addition data is required (decision 216). Ambiguity resolution program 200 determines whether addition data is required based on the amount of feedback received and if the feedback includes enough data to generate a new process addressing the ambiguity. In some embodiments, ambiguity resolution program 200 can run a simulation of the process (e.g., digital twin simulation) to ensure that the provided feedback resolves the ambiguity, while preventing the creation of additional ambiguity within the process. In the event ambiguity resolution program 200 determines additional data is not required (“no” branch, decision 216), ambiguity resolution program 200 generates a new workflow process based on the received feedback (218). In the event ambiguity resolution program 200 determines additional data is required (“yes” branch, decision 216), ambiguity resolution program 200 reverts to capturing an active workflow process and capturing relevant participants of the active workflow process. Capturing the relevant participants of the active workflow process includes removing the portion of relevant participants that have already provided the feedback in (214).

Ambiguity resolution program 200 generates a new process based on the received feedback (218). Ambiguity resolution program 200 generates the new process by transforming the active process utilizing participant feedback, where the new process addresses the previously identified ambiguities. In some embodiments, ambiguity resolution program 200 generates a pre-approval BPMN process flow for an analyst of the processing mining to approve and finalize to a final working model, where the analyst can add the additional user (i.e., participant) data to the system. In the example where a bank is attempting to streamline operations by reducing loan processing times and identifies ambiguity based on multiple unknown approval steps being present in the loan process, ambiguity resolution program 200 generates a new process based on the received feedback from the participants that further defined the unknown approval steps. Ambiguity resolution program 200 transforms the active process by feeding the data received from the participants into the workflow, where the data defines one or more variables associated with the unknown approval steps. In the example where an electronics manufacturer is attempting to lower lead times for deliveries and identifies multiple third party integrations that represent multiple instances of ambiguity are present in the process of manufacturing and logistical preparation, ambiguity resolution program 200 generates a new process based on the received feedback from the participants that further defined the third party integrations of software into the manufacturing and logistical preparation process. Ambiguity resolution program 200 transforms the active process by feeding the data received from the participants into the workflow, where the data defines one or more variables between the data processing tool and the third party software.

It is to be noted that ambiguity resolution program 200 can be an independent component of a process mining tool, a partially independent component and a partially integrated component of a process mining tool, or an integrated component of a process mining tool.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
capturing an active process with a plurality of components based on a plurality of event log files;
capturing a plurality of relevant participants of the active process;
identifying, based on the plurality of event log files, ambiguity associated with at least one component of the active process;
sending a poll to at least a portion of relevant participants from the plurality of relevant participants, wherein the poll identifies the ambiguity and includes a request to resolve the ambiguity;
receiving feedback from the portion of relevant participants; and
generating a new process by transforming the active process based on the feedback from the portion of relevant participants.

2. The computer-implemented method of claim 1, wherein each relevant participant from the plurality of relevant participants is a subject matter expert with an associated level of subject matter expertise.

3. The computer-implemented method of claim 1, wherein the ambiguity associated with the at least one component of the active process is determined based on one or more of black boxes, application programming interface (API) endpoints, third party integrations, unknown approval steps, and offline steps.

4. The computer-implemented method of claim 1, further comprising:
receiving a user opt-in selection for each relevant participants from the plurality of relevant participants who is a subject matter expert in a field associated with a given process.

5. The computer-implemented method of claim 1, further comprising:
aggregating the feedback received from the portion of relevant participants; and
generating a commonality score that includes usernames involved, potentially missing process steps, additional business process model and notation (BPMN) flow components, and diagram adjustments based on the aggregated feedback of the participants.

6. The computer-implemented method of claim 1, further comprising:
weighing the feedback received from the portion of relevant participants based on an associated level of subject matter expertise for each participant from the portion of relevant participants.

7. The computer-implemented method of claim 1, further comprising:
determining whether additional data is required based on an amount of feedback received from the portion of relevant participants;
responsive to determining the additional data is required, capturing the active process with the plurality of components based on the plurality of event log files; and
capturing another plurality of relevant participants of the active process, wherein the portion of relevant participants are removed from the other plurality of relevant participants of the active process.

8. A computer program product comprising:
one or more computer-readable storage media;
program instructions, stored on at least one of the one or more storage media, to capture, by a process mining tool, an active process with a plurality of components based on a plurality of event log files;
program instructions, stored on at least one of the one or more storage media, to capture, by the process mining tool, a plurality of relevant participants of the active process;
program instructions, stored on at least one of the one or more storage media, to identify, based on the plurality of event log files, ambiguity associated with at least one component of the active process;
program instructions, stored on at least one of the one or more storage media, to send a poll to at least a portion of relevant participants from the plurality of relevant participants, wherein the poll identifies the ambiguity and includes a request to resolve the ambiguity;
program instructions, stored on at least one of the one or more storage media, to receive feedback from the portion of relevant participants; and
program instructions, stored on at least one of the one or more storage media, to generate a new process by transforming the active process based on the feedback from the portion of relevant participants.

9. The computer program product of claim 8, wherein each relevant participant from the plurality of relevant participants is a subject matter expert with an associated level of subject matter expertise.

10. The computer program product of claim 8, wherein the ambiguity associated with the at least one component of the active process is determined based on one or more of black boxes, application programming interface (API) endpoints, third party integrations, unknown approval steps, and offline steps.

11. The computer program product of claim 8, further comprising:
program instructions, stored on at least one of the one or more storage media, to receive a user opt-in selection for each relevant participants from the plurality of relevant participants who is a subject matter expert in a field associated with a given process.

12. The computer program product of claim 8, further comprising:
program instructions, stored on at least one of the one or more storage media, to aggregate the feedback received from the portion of relevant participants; and
program instructions, stored on at least one of the one or more storage media, to generate a commonality score that includes usernames involved, potentially missing process steps, additional business process model and notation (BPMN) flow components, and diagram adjustments based on the aggregated feedback of the participants.

13. The computer program product of claim 8, further comprising:
program instructions, stored on at least one of the one or more storage media, to weigh the feedback received from the portion of relevant participants based on an associated level of subject matter expertise for each participant from the portion of relevant participants.

14. The computer program product of claim 8, further comprising:
program instructions, stored on at least one of the one or more storage media, to determine whether additional data is required based on an amount of feedback received from the portion of relevant participants;
program instructions, stored on at least one of the one or more storage media, responsive to determining the additional data is required, to capture, by the process mining tool, the active process with the plurality of components based on the plurality of event log files; and
program instructions, stored on at least one of the one or more storage media, to capture, by the process mining tool, another plurality of relevant participants of the active process, wherein the portion of relevant participants are removed from the other plurality of relevant participants of the active process.

15. A computer system comprising:
one or more processors, one or more computer-readable memories and one or more computer-readable storage media;
program instructions, stored on at least one of the one or more storage media for execution by at least one of the one or more processors via at least one of the one or more memories, to capture, by a process mining tool, an active process with a plurality of components based on a plurality of event log files;
program instructions, stored on at least one of the one or more storage media for execution by at least one of the one or more processors via at least one of the one or more memories, to capture, by the process mining tool, a plurality of relevant participants of the active process;
program instructions, stored on at least one of the one or more storage media for execution by at least one of the one or more processors via at least one of the one or more memories, to identify, based on the plurality of event log files, ambiguity associated with at least one component of the active process;
program instructions, stored on at least one of the one or more storage media for execution by at least one of the one or more processors via at least one of the one or more memories, to send a poll to at least a portion of relevant participants from the plurality of relevant participants, wherein the poll identifies the ambiguity and includes a request to resolve the ambiguity;
program instructions, stored on at least one of the one or more storage media for execution by at least one of the one or more processors via at least one of the one or more memories, to receive feedback from the portion of relevant participants; and
program instructions, stored on at least one of the one or more storage media for execution by at least one of the one or more processors via at least one of the one or more memories, to generate a new process by transforming the active process based on the feedback from the portion of relevant participants.

16. The computer system of claim 15, wherein each relevant participant from the plurality of relevant participants is a subject matter expert with an associated level of subject matter expertise.

17. The computer system of claim 15, wherein the ambiguity associated with the at least one component of the active process is determined based on one or more of black boxes, application programming interface (API) endpoints, third party integrations, unknown approval steps, and offline steps.

18. The computer system of claim 15, further comprising:
program instructions, stored on at least one of the one or more storage media for execution by at least one of the one or more processors via at least one of the one or more memories, to receive a user opt-in selection for each relevant participants from the plurality of relevant participants who is a subject matter expert in a field associated with a given process.

19. The computer system of claim 15, further comprising:
program instructions, stored on at least one of the one or more storage media for execution by at least one of the one or more processors via at least one of the one or more memories, to aggregate the feedback received from the portion of relevant participants; and
program instructions, stored on at least one of the one or more storage media for execution by at least one of the one or more processors via at least one of the one or more memories, to generate a commonality score that includes usernames involved, potentially missing process steps, additional business process model and notation (BPMN) flow components, and diagram adjustments based on the aggregated feedback of the participants.

20. The computer system of claim 15, further comprising:
program instructions, stored on at least one of the one or more storage media for execution by at least one of the one or more processors via at least one of the one or more memories, to weigh the feedback received from the portion of relevant participants based on an associated level of subject matter expertise for each participant from the portion of relevant participants.
